(19) United States
(12) Patent Application Publication
(10) Pub. No.: US 2015/0372529 A1
(43) Pub. Date: Dec. 24, 2015

(54) POWER LOSS DETECTION FOR WIRELESS CHARGING

(71) Applicant: NOKIA CORPORATION, Espoo (FI)

(72) Inventor: Harri LAMPINEN, Tampere (FI)

(21) Appl. No.: 14/667,003

(22) PCT Filed: Sep. 25, 2012
(86) PCT No.: PCT/IB2012/055097

§ 371 Date: Mar. 24, 2015

(51) Int. Cl. H02J 7/02; H04W 52/02; H02J 7/04

(52) U.S. Cl. CPC H02J 7/025; H02J 7/042; H04W 52/0251

(57) ABSTRACT

It is inter alia disclosed to an apparatus (100), comprising at least one receiving coil (110) configured to receive electromagnetic energy from a wireless signal provided by a wireless charger, an interface (140) connected to the at least one receiving coil (110) and configured to be connected to a rechargeable energy source for charging the rechargeable energy source with energy received at the at least one receiving coil (110), an analyser (120) configured to measure at least one parameter being indicative of a property of the wireless signal provided by the wireless charger and configured to control the charging of a rechargeable energy source connected to the interface (140) based on the at least one measured parameter.

### FIELD

Embodiments of this invention relate to apparatuses comprising at least one receiving coil configured to receive electromagnetic energy from a wireless signal provided by a wireless charger.

### BACKGROUND

From a consumer perspective the stand by time of a phone is always too short. Technically a lot of energy is wasted during idle mode or basic usage mode when user is not interacting or only using basic functionalities but the processor is active and consumes energy without delivering related consumer experience. Thus, frequently charging a battery of the phone is important in order to ensure that there is enough energy for operating the phone.

In order to increase comfort for a user wireless charging systems can be used, wherein the phone is wirelessly connected to a charger for receiving power from the charger and for charging the battery by using this received power. However, the degree of efficiency of such a wireless charging system may depend on the position of the phone with respect to the position of the charger. For instance, a miss-alignment between the phone and the charger and/or an external load placed in proximity to the phone and/or an increased distance between the phone and the charger may decrease the degree of efficiency.

### SUMMARY OF SOME EMBODIMENTS OF THE INVENTION

Thus, improving a wireless charging procedure may be desirable.

According to a first exemplary embodiment of an aspect of the invention, an apparatus is disclosed, the apparatus comprising at least one receiving coil configured to receive electromagnetic energy from a wireless signal provided by a wireless charger, an interface connected to the at least one receiving coil and configured to be connected to a rechargeable energy source for charging the rechargeable energy source with energy received at the at least one receiving coil, and an analyser configured to measure at least one parameter being indicative of a property of the wireless signal provided by the wireless charger and configured to control the charging of a rechargeable energy source connected to the interface based on the at least one measured parameter.

According to a second exemplary embodiment of an aspect of the invention, a method is disclosed, the method comprising measuring at least one parameter representative being indicative of a property of a wireless signal provided by a wireless charger, wherein the apparatus comprises at least one receiving coil configured to receive electromagnetic energy from a wireless signal provided by the wireless charger, and controlling a charging of a rechargeable energy source connected to an interface of the apparatus based on the at least one measured parameter, wherein the interface is connected to the at least one receiving coil and configured to be connected to a rechargeable energy source for charging the rechargeable energy source with energy received at the at least one receiving coil.

According to a third exemplary embodiment of an aspect of the invention, an apparatus is disclosed, which is configured to perform the method according to an aspect of the invention, or which comprises at least one receiving coil means for receiving electromagnetic energy from a wireless signal provided by a wireless charger, an interface means connected to the at least one receiving coil and configured to be connected to a rechargeable energy source for charging the rechargeable energy source with energy received at the at least one receiving coil, and an analyser means for measuring at least one parameter being indicative of a property of the wireless signal provided by the wireless charger and for controlling the charging of a rechargeable energy source connected to the interface based on the at least one measured parameter.

According to a fourth exemplary embodiment of the an aspect of the invention, an apparatus is disclosed, comprising at least one processor and at least one memory including computer program code, the at least one memory and the computer program code configured to, with the at least one processor, cause the apparatus at least to perform the method according to an aspect of the invention. The computer program code included in the memory may for instance at least partially represent software and/or firmware for the processor. Non-limiting examples of the memory are a Random-Access Memory (RAM) or a Read-Only Memory (ROM) that is accessible by the processor.

According to a fifth exemplary embodiment of an aspect of the invention, a computer program is disclosed, comprising program code for performing the method according to an aspect of the invention when the computer program is executed on a processor. The computer program may for instance be distributable via a network, such as for instance the Internet. The computer program may for instance be storable or encodable in a computer-readable medium. The computer program may for instance at least partially represent software and/or firmware of the processor.

According to a sixth exemplary embodiment of an aspect of the invention, a computer-readable medium is disclosed, having a computer program according to an aspect of the invention stored thereon. The computer-readable medium may for instance be embodied as an electric, magnetic, electro-magnetic, optic or other storage medium, and may either be a removable medium or a medium that is fixedly installed in an apparatus or device. Non-limiting examples of such a computer-readable medium are a RAM or ROM. The computer-readable medium may for instance be a tangible medium, for instance a tangible storage medium. A computer-readable medium is understood to be readable by a computer, such as for instance a processor.

In the following, features and embodiments pertaining to all of these above-described aspects of the invention will be briefly summarized.

The apparatus comprises at least one receiving coil configured to receive electromagnetic energy from a wireless signal provided by a wireless charger. For instance, the wireless charger may comprise a transmitting coil for transmitting electromagnetic energy which can be received by the at least one receiving coil of the apparatus when the apparatus is positioned in such a near distance to the wireless charger that the at least one receiving coil receives the wirelessly transmitted electromagnetic energy. For instance, apparatus may represent or may form part of a mobile apparatus.

The apparatus further comprises an interface connected to the at least one receiving coil and configured to be connected to a rechargeable energy source for charging the rechargeable energy source with energy received at the at least one receiving coil. For instance, said rechargeable energy source may comprise a battery and/or a capacitor or any other well suited rechargeable energy source configured to store electrical energy.

As an example, when the at least one receiving coil receives electromagnetic energy from the wireless charge, a voltage may be induced in each of the at least one receiving coil and can be used by the apparatus for charging a rechargeable energy source connected to the interface. Furthermore, for instance, the apparatus may comprise optional circuitry configured to receive power from the at least one receiving coil and configured to perform a charging of a rechargeable energy source connected to the interface.

Furthermore, the apparatus comprises an analyser configured to measure at least one representative being indicative of a property of the wireless signal provided by the wireless charger, and the analyser is configured to control the charging of a rechargeable energy source connected to the interface based on the at least one measured parameter.

For instance, said property of the wireless signal may represent a power of the wireless signal transmitted by the wireless charger, e.g. the power of the electromagnetic wave emitted from the at least one transmitting coil of the wireless charger. As an example, it has to be understood that the property of the wireless signal may represent other properties than the power of the wireless signal.

As an example, said measured at least one representative being indicative of a property of the wireless signal provided by the wireless charger may represent any physical parameter which can be measured at the apparatus and which is at least partially indicative of a property of the wireless signal transmitted by the wireless charger. For instance, said at least one parameter may be at least one of: a signal level of a signal associated with the wireless signal received at the apparatus, a waveform of a signal associated with the wireless signal received at the apparatus, a duty cycle of a signal associated with the wireless signal received at the apparatus, a frequency of a signal associated with the wireless signal received at the apparatus, a temperature measured at the apparatus, and a level of a magnetic field measured at the apparatus. For instance, the signal level may represent an amplitude level or an average signal level, wherein the signal level may represent a voltage level or a current level. For instance, the signal associated with the wireless signal received at the apparatus may represent any signal induced at the apparatus, e.g. at an inductive element which might represent a coil. It has to be understood that other parameters may also be measured and used by the analyser.

The analyser is configured to control the charging of a rechargeable energy source connected to the interface based on the measured at least one parameter. Accordingly, as an example, the analyser may be configured to determine a state of the wireless signal provided by a wireless charger based on the measured at least one parameter, wherein this detected state may be associated with a predefined property of wireless signal provided by a wireless charger, i.e., the analyser may for instance be configured to estimate a property of the wireless signal provided by a charger based on the measured at least one parameter. Based on the determined state and/or estimated property of the wireless signal the analyser may control the charging of a rechargeable energy source connected to the interface.

As an example, said predefined state and/or property of the wireless signal may include that the transmit power of the wireless signal provided at the wireless charger exceeds a predefined level, and/or that the distance between the apparatus (e.g., and thus the at least one receiving coil) and the wireless charger is too far for efficient charging, and/or that there is a misalignment between the at least one receiving coil and the wireless charger, and/or that there is an external load positioned in the electromagnetic field between the apparatus (e.g., the at least one receiving coil) and the wireless charger and/or in proximity to the wireless charger's magnetic field range. More exemplary details regarding said predefines state and/or property will be presented in the sequel.

As a non-limiting example, the distance may represent the distance between a predefined point (which may represent a mid-point) of the at least one receiving coil and a predefined point (which may represent a mid-point) of the at least one transmitting coil.

Furthermore, for instance, said controlling the charging of the rechargeable energy source connected to the interface may comprise at least one of starting a charging (i.e., switching from non-charging to charging), increasing a charging current during a charging, decreasing a charging current during charging, and stopping charging.

Accordingly, as an example, the analyser is configured to control the charging based on an estimated state and/or property of the wireless signal provided by the wireless charger which may enable that changes in the wireless signal provided by the wireless charger may be detected and charging can be adapted accordingly.

As a non-limiting example, the analyser may be connected to the at least one receiving coil, wherein said analyser may be configured to measure at least one parameter of the at least one parameter based on at least one signal provided by the at least one receiving coil.

For instance, the analyser may be configured to determine a frequency of the signal provided by the at least one receiving coil when a voltage is induced in the at least one receiving coil, e.g. by an electromagnetic field generated by a wireless charger. For instance, if a measured parameter represents a measured frequency of a signal of the at least one receiving coil, and if said measured frequency is less than a predefined frequency threshold or if said measured frequency exceeds a predefined frequency threshold, the analyser may be configured to stop charging or to reduce a charging current or may prevent that a charging of a rechargeable energy source connected to the interface can be started, since a low frequency, i.e., a measured frequency being less than the predefined frequency threshold or a measured frequency being higher than the predefined frequency threshold, may indicate that a property of the wireless signal provided by a charger corresponds to an inappropriate property for performing said wireless charging. For instance, it may depend on the type wireless charger whether a measured frequency being less than the predefined frequency threshold or a measured frequency being higher than the predefined frequency threshold indicates that a property of the wireless signal provided by a charger corresponds to an inappropriate property for performing said wireless charging. As an example, if the wireless charger increases the frequency when less power is transmitted, a measured frequency being less than the predefined frequency threshold may indicate that a property of the wireless signal provided by a charger corresponds to an inappropriate property for performing said wireless charging, and, vice versa, if the wireless charger decreases the frequency when less power is transmitted, a measured frequency being higher than the predefined frequency threshold may indicate that a property of the wireless signal provided by a charger corresponds to an inappropriate property for performing said wireless charging.

For instance, said inappropriate property may be the property that the transmission power of the wireless signal provided by the wireless charger is higher than a predefined power level threshold, which for instance may occur when the distance (or an absolute value of the distance) between the apparatus and a wireless charger is too high, or which may occur when there is an external load between the at least one receiving coil and the wireless charging and/or in proximity to the wireless charger's magnetic field range, or which may occur when there is a misalignment between the apparatus, and in particular of the at least one receiving coil, and the wireless charger. Accordingly, as an example, such an inappropriate property of the wireless signal might be detected by means of the at least one receiving coil, wherein other parameters than the measured frequency may also be used, and the analyser can control the charging of a rechargeable energy source connected to the interface accordingly, e.g., by means of reducing a charging current or by means of stopping charging or by means of preventing a start of a charging process.

According to an exemplary embodiment of an aspect of the invention, the analyser is configured to detect a predefined state of the wireless signal based on at least one parameter of the at least one measured parameter, wherein said analyser is further configured to control the charging of a rechargeable energy source connected to the interface including at least one of: reducing a charging current provided to the rechargeable energy source if a predefined state of the wireless signal is detected, stopping a charging of the rechargeable energy source if a predefined state of the wireless signal is detected, preventing start of charging of the rechargeable energy source if a predefined state of the wireless signal is detected.

As an example, said predefined state may include that the transmit power of the wireless signal provided at the wireless charger exceeds a predefined level, and/or that the distance between the apparatus (e.g., and thus the at least one receiving coil) and the wireless charger is too far and/or too near for efficient charging, and/or that there is a misalignment between the at least one receiving coil and the wireless charger, and/or that there is an external load positioned in the electromagnetic field between the apparatus (e.g., the at least one receiving coil) and the wireless charger and/or in proximity to the wireless charger's magnetic field range. Thus, for instance, these exemplary predefined states may be associated with the above mentioned inappropriate property of the wireless signal received at the apparatus, which may lead to charging with decreased efficiency and which may for instance cause hot temperature spots on the apparatus due to leakage induction and/or may cause hot temperature on a foreign object placed in proximity to the wireless charger's magnetic field range due to leakage induction.

For instance, if the detected predefined state indicates that the transmit power is too high, i.e., the transmit power exceeds a predefined power level, the controlling may comprise decreasing a charging current during charging of a rechargeable energy source connected to the interface or stopping the charging, or, if no charging is performed, preventing starting charging a rechargeable energy source connected to the interface. A similar (or same) controlling may be performed if the detected predefined states indicates that the distance (or an absolute value of the distance) between the apparatus and the wireless charger exceeds a maximum predefined distance, or if the detected predefined state indicates that an external load is detected, or if the detected predefined state indicates that there is a misalignment between the apparatus and the wireless charger.

Thus, the method allows to control the charging in accordance with the actual operating scenario, wherein the controlling is performed based on the measured at least one parameter being indicate of a property of the wireless signal of a wireless charger.

According to an exemplary embodiment of an aspect of the invention, the apparatus comprises at least one sensor, wherein the analyser is configured to measure a parameter of at least one of the at least one parameter based on a signal provided by each of said at least one sensor.

For instance, the measured at least one parameter may represent any parameter which can be measured at the apparatus and which is at least partially or completely indicative of a property of the wireless signal provided by the charger. Thus, the apparatus may comprise at least one sensor which is used by the analyser for measuring one parameter of the at least one parameter. The analyser may comprise an input configured to receive at least one signal from at least one sensor.

According to an exemplary embodiment of an aspect of the invention, the at least one sensor of the at least one sensor represents at least one further coil configured to receive electromagnetic energy.

For instance, the at least one further coil may be placed in proximity to one receiving coil of the at least one receiving coil of the apparatus, wherein proximity may be understood that a wireless signal received at the receiving coil is at least partially received at the at least one further coil.

Thus, the at least one further coil can be used to estimate a property and/or state of the wireless signal provided by a wireless charger in an efficient way since the at least one further coil is near to at least one receiving coil of the at least one receiving coil and, the signal of the at least one further coil is not influenced by the charging process carried out by power received from the at least one receiving coil.

For instance, the one further coil may represent a single turn coil or a multiple coil turn.

According to an exemplary embodiment of an aspect of the invention, one further coil of the at least one further coil at least partially surrounds one receiving coil of the at least one receiving coil.

According to an exemplary embodiment of an aspect of the invention, at least one further coil of the at least one further coil is placed in proximity to one receiving coil of the at least one receiving coil.

According to an exemplary embodiment of an aspect of the invention, a predefined state of the wireless signal is detected based on at least one of the following: a voltage measured at a further coil of the at least one further coils exceeds a predefined voltage threshold, and a frequency measured at a further coil of the at least one further coils is less than a predefined frequency threshold or a frequency measured at a further coil of the at least one further coils exceeds a predefined frequency threshold, and a waveform measured at a further coil of the at least one further coil deviates from a normal waveform, and a duty cycle measured at a further coil of the at least one further coil deviated from a normal duty cycle.

For instance, the checking whether a predefined state is detected based on at least one parameter of the measured at least one parameter comprise detecting whether a signal level measured at one coil of the at least one further coils exceeds a predefined voltage level threshold, and/or detecting whether a frequency measured at one coil of the at least one further coils or measured at one of the at least one receiving coils is less than a predefined frequency threshold or detecting whether a frequency measured at one coil of the at least one further coils or measured at one of the at least one receiving coils exceeds a predefined frequency threshold, and/or detecting whether a waveform measured at one coil of the at least one further coils deviates from a normal (i.e., predefined) waveform, and/or detecting whether a duty cycle measured at one coil deviates from a normal duty cycle.

For instance, said detecting whether a measured waveform deviates from a normal waveform may comprise determining a correlation factor between the measured waveform and the normal waveform, and if the determined correlation factor is less than a predefined value, it is detected that measured waveform deviates from the normal waveform, otherwise no deviation is detected. Furthermore, said detecting whether a duty cycle measured at one coil deviates from a normal duty cycle may comprise detecting whether the duty cycle is less than a predefined value and/or higher than a predefined value.

For instance, the measured parameter frequency and/or the measured parameter voltage level and/or the measured parameter duty cycle and/or the measured parameter waveform may be used for determining whether the transmission power Pin of the wireless charger exceeds a predefined threshold, which might indicate one of a predefined state.

Or, for instance, the measured parameter frequency and/or the measured parameter signal level may be used for detecting whether a distance (or an absolute value of a distance) between the apparatus and the wireless charger is outside a predefined range which enables efficient charging, i.e. it may indicate that the distance between the apparatus and the wireless charger is higher than a predefined maximum distance, whereas this state may be detected when the measured frequency is less (or, alternatively, is higher) than a predefined frequency threshold and/or the measured voltage level is higher than a predefined voltage level.

Or, for instance, the measured parameter frequency and/or the measured parameter signal level may be used for detecting whether an external load influences the wireless signal provided by the wireless charger to the apparatus, i.e. it may indicate that there is an external load, whereas this state may be detected when the measured frequency is less than a predefined frequency threshold (or, alternative, is higher than a predefined frequency threshold) and/or the measured voltage level is higher than a predefined voltage level.

According to an exemplary embodiment of an aspect of the invention, the analyser is configured to determine a misalignment of a position of the at least one receiving coil with respect to a position of the wireless charger based on a signal provided by at least one of the at least one further coil, and wherein the apparatus comprises an interface configured to provide directional information for correcting the misalignment.

According to an exemplary embodiment of an aspect of the invention, said at least one further coil represents at least two further coils arranged at predefined positions around the at least one receiving coil, wherein said determining a misalignment is performed based on a measured signal level of the signal of said at least two further coils.

According to an exemplary embodiment of an aspect of the invention, said at least one sensor of the at least one sensor is one of the following: a temperature sensor, a magnetic field sensor, and a structural element of the apparatus.

As an example, said temperature sensor may be placed adjacent or in proximity to the at least one receiving coil and/or on or in proximity to metal parts of the apparatus nearby the at least one receiving coil. Thus, for instance, a predefined state may be detected in step when a temperature measured by said temperature sensor exceeds a predefined threshold, wherein this may indicate that a lot of power leaks into structures of the apparatus, which might indicate that the distance (or an absolute value of the distance) between the apparatus and the wireless charger is too high and/or that there is a misalignment between the apparatus and the wireless charger. For instance, one or more of the temperature sensor may be placed a metal parts of the apparatus nearby the at least one receiving coil, in particular at positions where high temperature spots may occur due to leakage of transmitted power when there is a misalignment or if the distance is too long.

Furthermore, as an example, in a same way at least one magnetic field sensor may be placed adjacent or in proximity to the at least one receiving coil (e.g. but not at the same position as the receiving coil), wherein a predefined state may be detected in step when a magnetic field measured by said magnetic field sensor exceeds a predefined threshold.

And/or, as an example, at least one part of a metallic structural element of the apparatus may be used as at least one inductive sensor, wherein this at least one inductive sensor may be treated as at least one coil of the at least one further coil. Accordingly, for instance, a signal induced at this at least one inductive sensor may be used for measuring at least one parameter by means of the analyser. For instance, said metallic structural element of the apparatus may represent an element which is configured to carry at least one electronic element and/or non-electronic element of the apparatus, e.g. it may represent a kind of frame or board. This shows the advantage that no further coils are necessary, since this metallic structural element may already be existent in the apparatus. As an example, a camera deco of the apparatus might be used as inductive sensor, and/or a part of the chassis of a camera of the apparatus might be used as inductive sensor, and/or a part of the chassis of the apparatus might be used as inductive sensor, and/or an apparatus cover might be used as inductive sensor.

According to an exemplary embodiment of an aspect of the invention, a sensor of said at least one sensor is placed in proximity to a receiving coil of the at least one receiving coil.

According to an exemplary embodiment of an aspect of the invention, the analyser is configured to measure the parameter of at least one of the at least one parameter based on a signal provided by the at least one receiving coil.

For instance, the checking whether a predefined state is detected based on at least one parameter of the measured at least one parameter comprise detecting whether a frequency measured at one coil of the at least one receiving coil is less (or, alternatively, is higher) than a predefined frequency threshold.

For instance, the measured parameter frequency may be used for determining whether the transmission power Pin of the wireless charger exceeds a predefined threshold, which might indicate one of a predefined state.

Or, for instance, the measured parameter frequency may be used for detecting whether a distance between the apparatus and the wireless charger is outside a predefined range which enables efficient charging, i.e. it may indicate that the distance (or an absolute value of a distance) between the apparatus and the wireless charger is higher than a predefined maximum distance, whereas this state may be detected when the measured frequency is less (or, alternatively, is higher) than a predefined frequency threshold and/or the measured voltage level is higher than a predefined voltage level. For instance, said distance may represent a distance in one direction of a coordinate system.

Or, for instance, the measured parameter frequency may be used for detecting whether an external load influences the wireless signal provided by the wireless charger to the apparatus, i.e. it may indicate that there is an external load, whereas this state may be detected when the measured frequency is less (or, alternatively, is higher) than a predefined frequency threshold and/or the measured voltage level is higher than a predefined voltage level.

According to an exemplary embodiment of an aspect of the invention, a predefined state of the wireless signal is detected based on one of the following: a frequency measured at a receiving coil of the at least one receiving coils is less than a predefined frequency threshold, and a frequency measured at a receiving coil of the at least one receiving coils is higher than a predefined frequency threshold.

For instance, it may depend on the type wireless charger whether a measured frequency being less than the predefined frequency threshold or a measured frequency being higher than the predefined frequency threshold indicates that a property of the wireless signal provided by a charger corresponds to an inappropriate property for performing said wireless charging, wherein said inappropriate property may represent said predefined state of the wireless signal. As an example, if the wireless charger increases the frequency when less power is transmitted, a measured frequency being less than the predefined frequency threshold may indicate that a property of the wireless signal provided by a charger corresponds to an inappropriate property for performing said wireless charging, and, vice versa, if the wireless charger decreases the frequency when less power is transmitted, a measured frequency being higher than the predefined frequency threshold may indicate that a property of the wireless signal provided by a charger corresponds to an inappropriate property for performing said wireless charging.

According to an exemplary embodiment of an aspect of the invention, said analyser is configured to determine a power received by the at least one receiving coil, wherein said analyser is further configured to detect a predefined state of the wireless signal if said measured power is approximately constant while a parameter of one of the at least one parameter changes significantly.

Thus, for instance, it may be checked whether the power provided by the at least one receiving coil is substantially the same, whereas the frequency measured at one of the receiving coils and/or the frequency measured at one of the optional at least one further coils is less (or, alternatively, is higher) than a predefined threshold, which might indicate that the transmit power is too high, and/or the distance (or an absolute value of a distance) between the wireless charger and the apparatus exceeds a predefined distance, and/or that there is an external load.

According to an exemplary embodiment of an aspect of the invention, said predefined state indicates that the transmit power of the wireless charger exceeds a predefined power level.

According to an exemplary embodiment of an aspect of the invention, said measured at least one parameter is at least one of: a signal level of a signal associated with the wireless signal, a waveform of a signal associated with the wireless signal, a duty cycle of a signal associated with the wireless signal, a frequency of a signal associated with the wireless signal, a temperature, and a signal level of a magnetic field.

Furthermore, as another example, a predefined state may be detected when a waveform of a signal of a coil of the at least one further coil and/or the at least one receiving coils differs from a normal waveform of a signal of this coil. For instance, such a deviating waveform might indicate an external load influencing the electromagnetic wave received at the at least one receiving coil and/or might indicate a misalignment and/or that a distance (or an absolute value of the distance) between the apparatus and the wireless charger exceeds a predefined value, and thus might be indicative that the transmission power Pin of the wireless charger might exceed a predefined threshold. Or, for instance, a predefined state may be detected in step when a duty cycle measured by means of a signal of a coil of the at least one further coil and/or the at least one receiving coils differs from a normal duty cycle.

According to an exemplary embodiment of an aspect of the invention, said apparatus represents a mobile apparatus, in particular a mobile phone.

Other features of all aspects of the invention will be apparent from and elucidated with reference to the detailed description of embodiments of the invention presented hereinafter in conjunction with the accompanying drawings. It is to be understood, however, that the drawings are designed solely for purposes of illustration and not as a definition of the limits of the invention, for which reference should be made to the appended claims. It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures show:

FIG. 1: A first example embodiment of an apparatus according to an aspect of the invention;

FIG. 2: a flowchart of a first example embodiment of a method according to an aspect of the invention;

FIG. 3: A second example embodiment of an apparatus according to an aspect of the invention;

FIG. 4: a flowchart of a second example embodiment of a method according to an aspect of the invention;

FIG. 5a: an exemplary measured curve of a frequency measured at one of the at least one further coil versus the distance between the apparatus and the wireless charger for a first exemplary scenario;

FIG. 5b: an exemplary measured curve of a transmission power of the wireless charger frequency versus the distance between the apparatus and the wireless charger for the first exemplary scenario;

FIG. 5c: an exemplary measured curve of a transmission power of the wireless charger frequency versus the distance between the apparatus and the wireless charger for the first exemplary scenario;

FIG. 5d: an example embodiment of a system according to an aspect of the invention; and

FIG. 6: an example embodiment of an arrangement of a receiving coil and a plurality of further coils according to an aspect of the invention.

### DETAILED DESCRIPTION OF EMBODIMENTS OF THE INVENTION

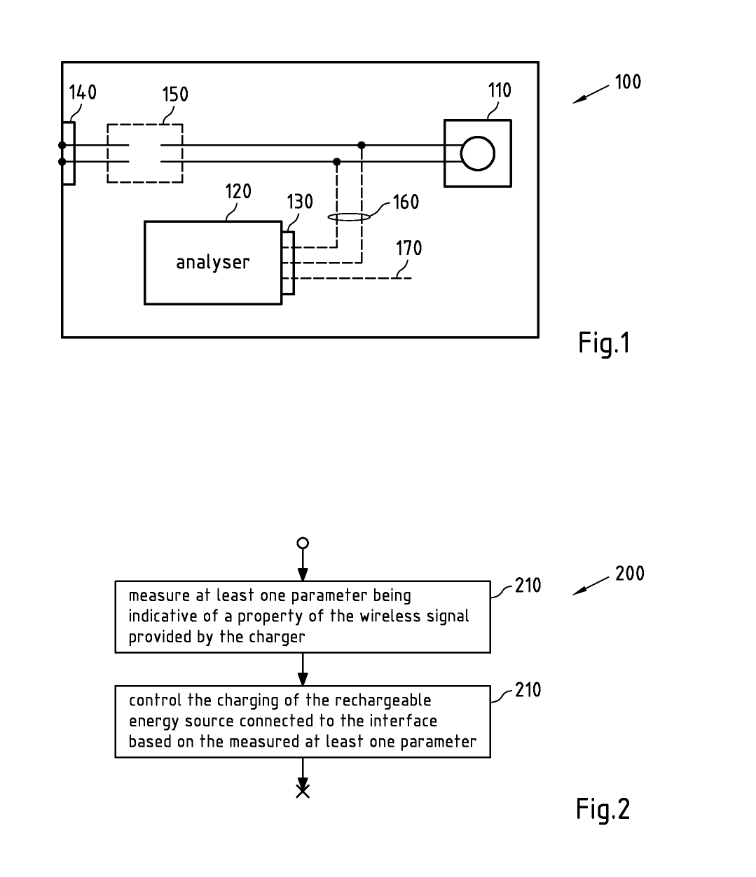

FIG. 1 depicts a first example embodiment of an apparatus 100 according to an aspect of the invention. This first example embodiment of an apparatus will be explained in conjunction with the flowchart 200 of a first example embodiment of a method 200 according to an aspect of the invention shown in FIG. 2. The steps of this flowchart 200 may for instance be defined by a program code of a computer program that is stored on a tangible storage medium. Tangible storage medium may for instance embody a program memory, and the computer program may then be executed by a processor.

Apparatus 100 comprises at least one receiving coil 110 configured to receive electromagnetic energy from a wireless signal provided by a wireless charger (not depicted in FIG. 1). For instance, the wireless charger may comprise a transmitting coil for transmitting electromagnetic energy which can be received by the at least one receiving coil 110 of the apparatus 100 when the apparatus 100 is positioned in such a near distance to the wireless charger that the at least one receiving coil 110 receives the wirelessly transmitted electromagnetic energy. For instance, apparatus 100 may represent or may form part of a mobile apparatus, e.g. a mobile phone.

The apparatus 100 further comprises an interface 140 connected to the at least one receiving coil 110 and configured to be connected to a rechargeable energy source (not depicted in FIG. 1) for charging the rechargeable energy source with energy received at the at least one receiving coil 110. For instance, said rechargeable energy source may comprise a battery and/or a capacitor or any other well suited rechargeable energy source configured to store electrical energy.

As an example, when the at least one receiving coil 110 receives electromagnetic energy from the wireless charge, a voltage may be induced in each of the at least one receiving coil 110 and can be used by the apparatus 100 for charging a rechargeable energy source connected to the interface 140. Furthermore, for instance, the apparatus 100 may comprise optional circuitry 150 configured to receive power from the at least one receiving coil 110 and configured to perform a charging of a rechargeable energy source connected to the interface 140.

Furthermore, the apparatus comprises an analyser 130 configured to measure at least one representative being indicative of a property of the wireless signal provided by the wireless charger, and the analyser 130 is configured to control the charging of a rechargeable energy source connected to the interface 140 based on the at least one measured parameter.

For instance, said property of the wireless signal may represent a power of the wireless signal transmitted by the wireless charger, e.g. the power of the electromagnetic wave emitted from the at least one transmitting coil of the wireless charger. As an example, it has to be understood that the property of the wireless signal may represent other properties than the power of the wireless signal.

As an example, said measured at least one representative being indicative of a property of the wireless signal provided by the wireless charger may represent any physical parameter which can be measured at the apparatus 100 and which is at least partially indicative of a property of the wireless signal transmitted by the wireless charger. For instance, said at least one parameter may be at least one of: a signal level of a signal associated with the wireless signal received at the apparatus 100, a waveform of a signal associated with the wireless signal, a duty cycle of a signal associated with the wireless signal, a frequency of a signal associated with the wireless signal, a temperature measured at the apparatus 100, and an amplitude of a magnetic field measured at the apparatus 100. For instance, the signal level may represent an amplitude level or an average signal level, wherein the signal level may represent a voltage level or a current level. For instance, the signal associated with the wireless signal received at the apparatus 100 may represent any signal induced at the apparatus 100, e.g. at an inductive element which might represent a coil. It has to be understood that other parameters may also be measured and used by the analyser 120.

In a step 220 the analyser controls the charging of a rechargeable energy source connected to the interface 140 based on the measured at least one parameter. Accordingly, as an example, the analyser 140 may be configured to determine a state of the wireless signal provided by a wireless charger based on the measured at least one parameter, wherein this detected state may be associated with a predefined property of wireless signal provided by a wireless charger, i.e., the analyser 140 may for instance be configured to estimate a property of the wireless signal provided by a charger based on the measured at least one parameter. Based on the determined state and/or estimated property of the wireless signal the analyser may control the charging of a rechargeable energy source connected to the interface 140.

As an example, said predefined state and/or property of the wireless signal may include that the transmit power of the wireless signal provided at the wireless charger exceeds a predefined level, and/or that the distance between the apparatus 100 (e.g., and thus the at least one receiving coil 110) and the wireless charger is too far for efficient charging, and/or that there is a misalignment between the at least one receiving coil 110 and the wireless charger, and/or that there is an external load positioned in the electromagnetic field between the apparatus 100 (e.g., the at least one receiving coil 110) and the wireless charger and/or in proximity to the wireless charger's magnetic field range. More exemplary details regarding said predefines state and/or property will be presented in the sequel.

Furthermore, for instance, said controlling the charging of the rechargeable energy source connected to the interface 140 performed in step 220 may comprise at least one of starting a charging (i.e., switching from non-charging to charging), increasing a charging current during charging, decreasing a charging current during charging , and stopping charging.

Accordingly, as an example, the analyser 120 is configured to control the charging based on an estimated state and/or property of the wireless signal provided by the wireless charger which may enable that changes in the wireless signal provided by the wireless charger may be detected and charging can be adapted accordingly.

For instance, the measured at least one parameter may represent any parameter which can be measured at the apparatus 100 and which is at least partially or completely indicative of a property of the wireless signal provided by the charger. Thus, the apparatus 100 may comprise at least one sensor which is used by the analyser 120 for measuring one parameter of the at least one parameter. The analyser 120 may comprise an input 130 configured to receive at least one signal from at least one sensor.

As an example, as exemplarily indicated by optional dashed lines 160 in FIG. 1, the analyser 120 may be connected to the at least one receiving coil 110, wherein said analyser 120 is configured to measure at least one parameter of the at least one parameter based on at least one signal provided by the at least one receiving coil 110. Thus, as an example, the at least one receiving coil may represent at least one sensor of the at least one sensor.

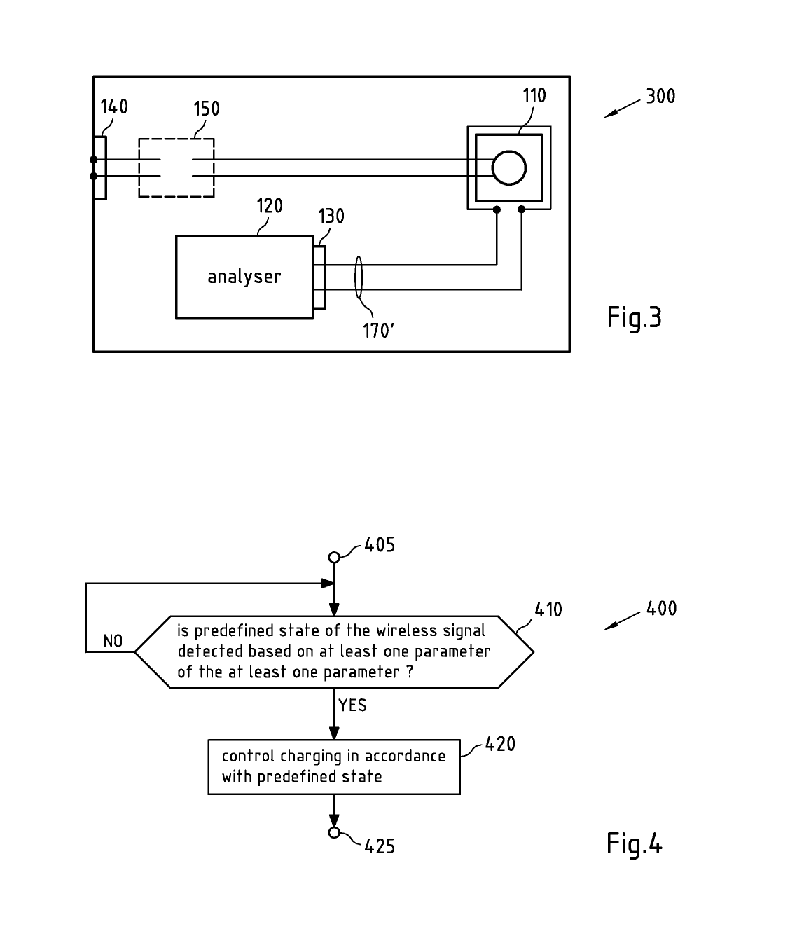

For instance, the analyser 120 may be configured to determine a frequency of the signal 160 provided by the at least one receiving coil 110 when a voltage is induced in the at least one receiving coil 110, e.g. by an electromagnetic field generated by a wireless charger. And/or, the analyser 120 may be configured to determine an signal level of the signal provided by the at least one receiving coil 110 when a voltage is induced in the at least one receiving coil 110, wherein for instance this signal level may represent an amplitude of a voltage induced in the at least one receiving coil 110 or an amplitude of a current induced in the at least one receiving coil 110. As an example, this amplitude may be considered as a representative of an average value of the signal, e.g. a average voltage or average current value, or, as an example, the amplitude may be considered as a peak value of the signal, a e.g. a peak voltage or peak current value. For instance, if a measured parameter represents a measured frequency of a signal of the at least one receiving coil 110, and if said measured frequency is less than a predefined frequency threshold, or, alternative, if said measured frequency is higher than a predefined frequency threshold, the analyser 120 may be configured to stop charging or to reduce a charging current or may prevent that a charging of a rechargeable energy source connected to the interface 100 can be started, since a low frequency, i.e., a measured frequency being less than the predefined frequency threshold, may indicate that a property of the wireless signal provided by a charger corresponds to an inappropriate property for performing said wireless charging or a measured frequency being higher than the predefined frequency threshold, may indicate that a property of the wireless signal provided by a charger corresponds to an inappropriate property for performing said wireless charging, which may depend on the type of the wireless charger. As an example, if the wireless charger increases the frequency when less power is transmitted, a measured frequency being less than the predefined frequency threshold may indicate that a property of the wireless signal provided by a charger corresponds to an inappropriate property for performing said wireless charging, and, vice versa, if the wireless charger decreases the frequency when less power is transmitted, a measured frequency being higher than the predefined frequency threshold may indicate that a property of the wireless signal provided by a charger corresponds to an inappropriate property for performing said wireless charging. For instance, said inappropriate property may be the property that the transmission power of the wireless signal provided by the wireless charger is higher than a predefined threshold, which for instance may occur when the distance between the apparatus 100 and a wireless charger is too high, or which may occur when there is an external load between the at least one receiving coil 110 and the wireless charging and/or in proximity to the wireless charger's magnetic field range, or which may occur when there is a misalignment between the apparatus, and in particular of the at least one receiving coil 110, and the wireless charger. Accordingly, as an example, such an inappropriate property of the wireless signal might be detected by means of the at least one receiving coil 110, wherein other parameters than the measured frequency may also be used, and the analyser 120 can control the charging of a rechargeable energy source connected to the interface 140 accordingly. For instance, these explanations may also hold for the at least one further coil 310 depicted in FIG. 3.

More exemplary details regarding said inappropriate properties which may also hold for examples using other sensor than the at least one receiving coils and/or for other examples of measured parameters will be presented in the sequel. For instance, as indicated by optional dashed line 170 in FIG. 1, the input 130 of the analyser 120 may be connected to at least one further sensor in order to measure at least one parameter.

Furthermore, it has to be understood that the connection of the at least one receiving coil 110 to the input 130 only represents an example, which might be omitted. Thus, as an example, the analyser 120 may be configured not to use the at least one receiving coil 110 for measuring the at least one parameter, i.e., the analyser may be configured only to use sensors (i.e. at least one sensor) being different from the at least one receiving coil 110 for measuring the at least one parameter. For instance, this might show the advantage that direct influences from the charging process, which may be reflected by the at least one receiving coil 110 when providing power to the interface 140 for charging a connected rechargeable energy source, might be reduced or omitted.

FIG. 3 depicts a second example embodiment of an apparatus 300 according to an aspect of the invention, wherein this apparatus 300 may at least partially be based on apparatus 100 as mentioned with respect to first embodiment of an apparatus according to an aspect of the invention depicted in FIG. 1. Thus, the explanations given with respect to apparatus 100 depicted in FIG. 1 may at least partially also hold for apparatus 300 depicted in FIG. 3.

Compared to apparatus 100 depicted in FIG. 1, apparatus 300 comprises at least one further coil 310 configured to receive electromagnetic energy connected to the interface 130 of the analyser, as exemplarily depicted by signal lines 170′ in FIG. 3. Please note that FIG. 3 only shows one further coil 310, but is has to be understood that more than one further coil 310 may be used by the analyser 120. This at least one further coil 130 is used by the analyser for measuring at least one parameter of the at least one parameter.

For instance, the at least one further coil 310 may be placed in proximity to one receiving coil of the at least one receiving coil 110 of the apparatus 100, wherein proximity may be understood that a wireless signal received at the receiving coil is at least partially received at the at least one further coil 310.

Furthermore, as an example, one further coil of at least one further coil 310 may at least partially surround (which may comprise completely surrounding) one receiving coil of the at least one receiving coil 110, as exemplarily shown in FIG. 3. For instance, the one further coil may represent a single turn coil or a multiple coil turn.

Thus, the at least one further coil 310 can be used to estimate a property and/or state of the wireless signal provided by a wireless charger in an efficient way since the at least one further coil 310 is near to at least one receiving coil of the at least one receiving coil 110 and, the signal of the at least one further coil 310 is not influenced by the charging process carried out by power received from the at least one receiving coil 110.

For instance, the analyser 120 may be configured to measure a signal level of a signal 170′ of at the least one further coil 310, and/or a waveform of a signal 170′ of at the least one further coil 310, and/or a duty cycle of a signal 170′ of at the least one further coil 310, and/or a frequency of the of a signal 170′ of at the least one further coil 310 as at least one parameter of said at least one parameter, wherein each of said at least one parameter measured based on at least one signal of the at least one further coil 310 may be at least partially indicative of a property of the wireless signal provided at the wireless charger, since the at least one further coil 310 may be arranged in a way that the at least one further coil 310 is configured to receive the wireless signal provided by the wireless charger at least partially.

Thus, based on this at least one parameter measured based on the at least one further coil 310, the analyser 120 may be configured to control the charging of a rechargeable energy source connected to the interface 140, e.g. as mentioned above.

More exemplary details regarding the use of this at least one further coil 310 will be explained as further examples with respect to the flowchart of a second example embodiment of a method 400 according to an aspect of the invention depicted in FIG. 4, which may be used for any of the above described apparatuses 100 and 300.

In a step 410 of method 400 depicted in FIG. 4 it is checked whether a predefined state of the wireless signal provided by a wireless charger is detected based on at least one parameter of the measured at least one parameter.

As an example, said predefined state may include that the transmit power of the wireless signal provided at the wireless charger exceeds a predefined level, and/or that the distance between the apparatus 100 (e.g., and thus the at least one receiving coil 110) and the wireless charger is too far for efficient charging, and/or that there is a misalignment between the at least one receiving coil 110 and the wireless charger, and/or that there is an external load positioned in or in proximity to the wireless charger's magnetic field range.

For instance, if at least one parameter of the at least one parameter is measured based on a signal 160 provided by the at least one receiving coil 110 and/or based on a signal 170′ provided by the at least one further coil 310, this checking performed in step 410 may comprise at least one of detecting whether a signal level measured at one coil of the at least one further coils or measured at one coil of the at least one receiving coils 110 exceeds a predefined signal level threshold, and detecting whether a frequency measured at one coil of the at least one further coils or measured at one of the at least one receiving coils 110 is less (or, alternatively, is higher) than a predefined frequency threshold, in order to detect a predefined state.

For instance, if is detected that a frequency is less (or, alternative, is higher) than a predefined frequency threshold, this may indicate that the distance between the apparatus and the wireless charger is outside a predefined range which enables efficient charging, i.e. it may indicate that the distance (or an absolute value of the distance) between the apparatus and the wireless charger is higher than a predefined maximum distance.

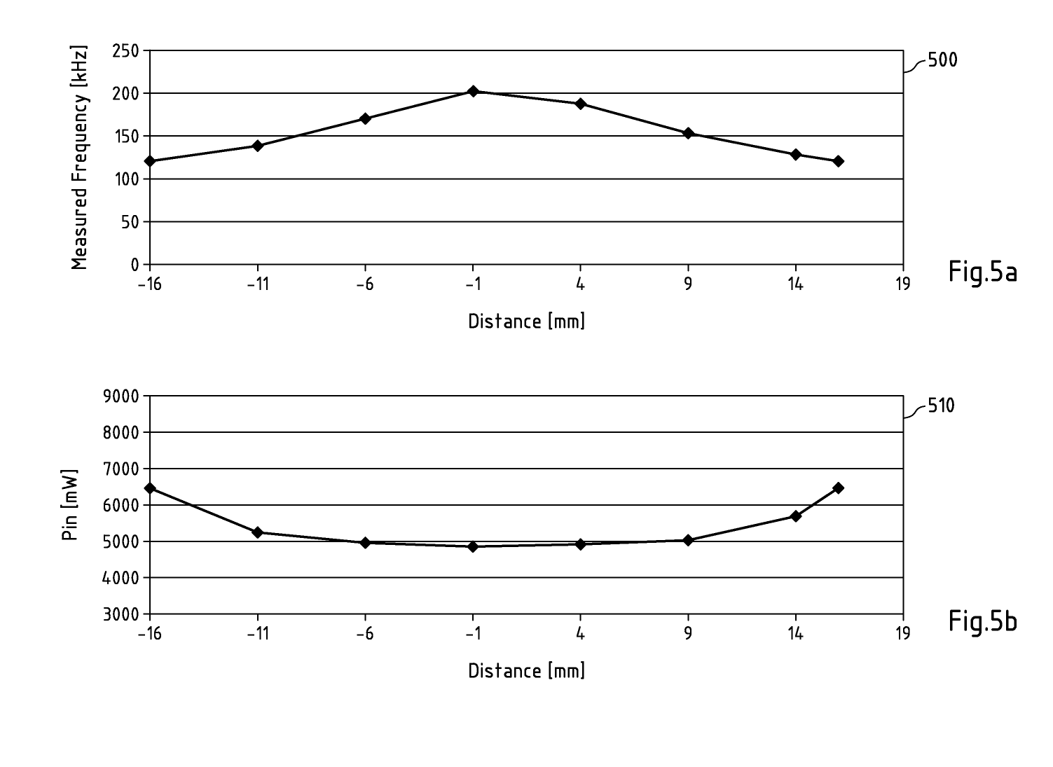

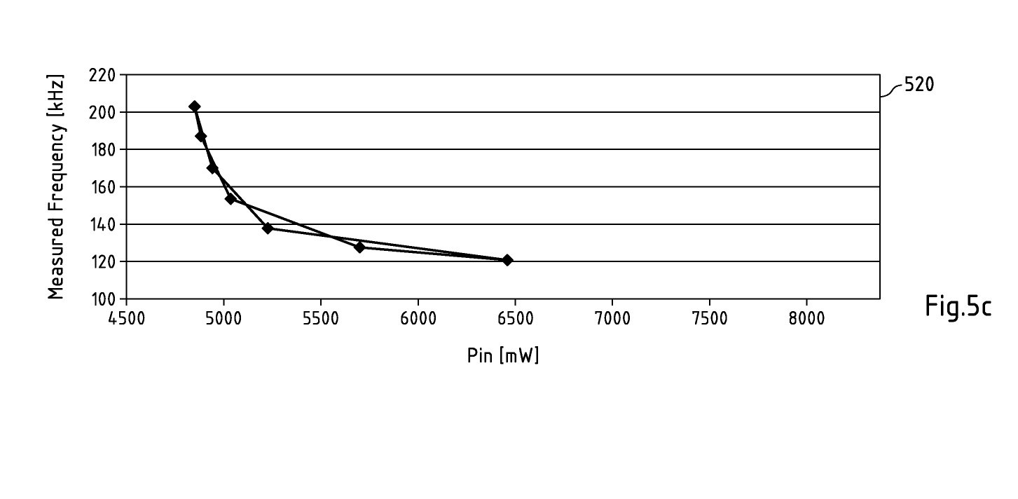

As an example, FIG. 5a depicts an exemplary measured curve 500 of a frequency measured at one of the at least one further coil 310 versus the distance between the apparatus and the wireless charger, wherein this distance may be considered as a representative between the at least one receiving coil 110 and the wireless charger, wherein in this example the frequency is measured at different distances between the apparatus 505 and the wireless charger 550 in an y-direction depicted in FIG. 5d, wherein the apparatus 505 may represent any of the above described apparatuses 100 and 300, wherein the at least one receiving coil 540 of apparatus 505 may represent the at least one receiving coil 110 depicted in FIG. 1 or in FIG. 3 and wherein the wireless charger 550 comprises at least one transmit coil 560. Furthermore, the apparatus 505 may comprise the at least one further coil 310 (not depicted in FIG. 5d).

The example of a system 500′ depicted in FIG. 5d may be assumed to show a perfect alignment of the at least one receiving coil 540 with respect to the at least one transmitting coil 560 in y-direction, wherein the mid 545 of the at least one receiving coil 540 is associated with the same y-coordinate as the mid 565 of the at least one transmitting coil 560. This position may be defined as distance d=0 with respect to the y-direction of the coordinate system 570. For instance, if the distance in y-direction is d>0 with respect to the example system 500′ depicted in FIG. 5d, the wireless charger 550 may be moved in positive y-direction and/or the apparatus 505 may be moved in negative y-direction compared to the position depicted in FIG. 5d, and if the distance in y-direction is d<0, the wireless charger 550 may be moved in negative y-direction and/or the apparatus 505 may be moved in positive y-direction compared to the position depicted in FIG. 5d, but any other definition of a coordinate system may for instance be used.

Furthermore, for the same scenario as used in FIG. 5a, i.e., measuring the frequency of a signal of one further coil 310, FIG. 5b depicts an exemplary measured curve 510 of the transmission power Pin of the wireless signal provided at the wireless charger versus the distance in y-direction between the apparatus and the wireless charger. For each point of measurement depicted in FIGS. 5a and 5b, the power received at the at least one receiving coil was approximately (or exactly) constant, i.e., the output power of the at least one receiving coil 310 has been kept constant in this example of measurement setup.

It can be seen from FIG. 5b that the transmission power Pin increases when the distance in y-direction between the apparatus and the wireless charger is too high , e.g. if the absolute value of distance may be higher than 8 mm, i.e. if the distance is higher than 8 mm or less than −8 mm, in this example, which may be assumed to represent one of the predefined states used in step 410.

Thus, for instance, with respect to the y-direction, wherein the y-direction may be assumed to represent the longitudinal direction of the at least one receiving coil 540, a predefined state may be detected if the absolute value of the distance in y-direction is higher than a predefined value. Furthermore, as an example, a predefined state may be detected if a distance in z-direction is higher than a predefined value or if an absolute value of a distance in z-direction is higher than a predefined value, and/or, a predefined state may be detected if a distance in x-direction is higher than a predefined value, wherein it may be assumed that the x-direction is perpendicular to a surface 506 of the apparatus 505 which may cover the at least one receiving coil 540 or where the at least one receiving coil 540 may be mounted on, wherein the surface 506 of the apparatus may be configured to match at least partially with an opposing surface 551 of the wireless charger 550, wherein the at least one transmitting coil 560 is placed behind or on the surface 551 of the wireless charger 550.

For instance, it has to be understood that the adjustment of the exemplary coordinate system 570 depicted in FIG. 5d may be chosen in a different way. Furthermore, as an example, the distance may represent the distance between a predefined point 546 (which may represent a mid-point) of the at least one receiving coil 540 and a predefined point 566 (which may represent a mid-point) of the at least one transmitting coil 560. Furthermore, for instance, it may also be possible that there exist some tilt between that least one receiving coil 540 and the at least one transmitting coil 560 which might for instance be causes if the apparatus includes camera deco/bump. Thus, for instance and depending on the apparatus and the scenario, a perfect alignment may for instance also be assumed when there is some tilt between the at least one receiving coil and the at least one transmitting coil, wherein, as an example, a perfect alignment may also be present if there is a foreign between the coils but the at least one receiving coil 540 and the at least one transmitting coil 560 are placed in good position to each other in order to ensure good or optimal wireless power transmission with respect to this specific scenario.

Furthermore, it has to be understood that the arrangement depicted in FIG. 5d only represents an example. Although FIG. 5d depicts apparatus 505 and wireless charger 550 in a horizontal position to each other for performing the wireless charging, the apparatus 505 and the wireless charger 550 may also be placed on top of each other, wherein the at least one receiving coil 540 of the apparatus 505 may be placed at the top of the apparatus 505 and the at least one transmitting coil of the wireless charger 550 may be placed at the bottom of the wireless charger 550 or vice versa.

Furthermore, as can be seen from FIG. 5a, the measured parameter frequency may be used for detecting whether this state, i.e., whether the distance between the apparatus and the wireless charger is too high, by means of checking whether the measured frequency is less a predefined threshold or not, and wherein this predefined state is detected when the measured frequency is less than the predefined threshold. For instance, with regard to the example depicted in FIGS. 5a and 5b, the frequency threshold may be chosen to be approximately 160 kHz, but any other well-suited frequency threshold may also be used, which might depend on the applied scenario, in particular on the applied wireless charger and/or the coil used for measuring the frequency. It has to be understood that in case another type of wireless charger is used, a measured frequency being higher than a predefined frequency threshold may be used for deterring this state, i.e., whether the distance between the apparatus and the wireless charger is too high.

As an example, said predefined threshold frequency may be determined by means of measurements when using the apparatus and the wireless charger at different operating points, wherein some of the operating points may correspond to one of the predefined states used in step 410, and wherein other operating points may correspond to normal operating points, wherein such a normal operating point might for instance be associated with a transmit power Pin being less than a predefined power value. For instance, it may be assumed that the apparatus may be configured to receive wireless power from a standardized type of wireless charger such that a predefined threshold determined as mentioned above may hold for most or all of scenarios when the apparatus charged with a wireless charger.

FIG. 5c depicts an exemplary measured curve 520 of a tranmission power of the wireless charger frequency versus the distance in y-direction between the apparatus 505 and the wireless charger 550 for the exemplary scenario applied with respect to the measured curves depicted in FIGS. 5a and 5b and with respect to the example system 500′ depicted in FIG. 5d.

As can be seen from FIG. 5c, the measured frequency may be used for determining whether the transmission power Pin of the wireless charger exceeds a predefined threshold, which might indicate a predefined state used in 410. For instance, as an example, with respect to the scenario applied in FIG. 5c, the predefined frequency threshold may be chosen to be approximately 160 kHz, but any other well-suited frequency threshold may also be used, which might depend on the applied scenario, in particular on the applied wireless charger and/or the coil used for measuring the frequency.

Accordingly, as exemplarily mentioned with respect to FIGS. 5a to 5c, a frequency measured at one of the further coils 310 may be used as a parameter by the analyser 120, wherein a predefined state may be detected in step 410 when a measured frequency is less (or, alternatively, is higher) than a predefined frequency threshold. Such a frequency threshold may also be used for a frequency measured based on a signal of one coil of the at least one receiving coil 540, wherein a measured frequency being less (or, alternatively, higher) than the predefined frequency threshold may be indicative that the transmit power Pin is higher than a predefined power threshold.

Furthermore, as an example, a predefined state indicating that an external load influences the electromagnetic field provided by the wireless charger to the at least one receiving coil 540 might be detected based on a measured frequency measured based on a signal of one coil of the at least on further coil and/or at least one receiving coil 540. For instance, if an external load, e.g. a coin, is in proximity to the at least one receiving coil (e.g., under a receiving coil or over the receiving coil or adjacent to the receiving coil), the frequency measured at one coil of the at least one receiving coil 540 may decrease and/or the frequency measured at one coil of the at least one further coil 310 may decrease compared to a scenario without external load, or, for instance, dependent on the type of the wireless charger, the frequency measured at one coil of the at least one receiving coil 540 may increase and/or the frequency measured at one coil of the at least one further coil 310 may increase compared to a scenario without external load. Accordingly, a foreign object detection may be performed as mentioned above.

As another example, a predefined state may be detected in step 410 when a voltage measured at one of the at least one further coils 310 is higher than a predefined voltage. For instance, it may be assumed that such a high voltage measured at one of the at least one further coils 310 may indicate that the transmit power Pin of the wireless charger exceeds a predefined threshold.

Furthermore, for instance, the at least one further coil 310 may represent a plurality of further coils which may be arranged at different positions of the apparatus, e.g. at different positions around the at least one of the at least one receiving coil. Then, for instance, if the voltage measured at one of the plurality of further coils exceeds a predefined voltage threshold, it might be assumed that there is a misalignment between the apparatus and the wireless charger, wherein this further coil receives too much energy due to the misalignment. Thus, as an example, a misalignment might be detected in step 410 based on a voltage measured at one of the plurality of further coils 310, which may also work for only one single further coil 310, but then the misalignment may for instance only be detected in one direction.

For instance, the at least one sensor may comprise at least one of a temperature sensor, a magnetic field sensor and an inductive sensor being defined by a structural element of the apparatus.

As an example, said temperature sensor may be placed adjacent or in proximity to the at least one receiving coil 540 and/or on or in proximity to metal parts of the apparatus 505 nearby the at least one receiving coil 540. Thus, for instance, a predefined state may be detected in step 410 when a temperature measured by said temperature sensor exceeds a predefined threshold, wherein this may indicate that a lot of power leaks into structures of the apparatus, which might indicate that the distance between the apparatus and the wireless charger is too high and/or that there is a misalignment between the apparatus and the wireless charger. For instance, one or more of the temperature sensor may be placed a metal parts of the apparatus nearby the at least one receiving coil, in particular at positions where high temperature spots may occur due to leakage of transmitted power when there is a misalignment or if the distance is too long.

Furthermore, as an example, in a same way at least one magnetic field sensor may be placed adjacent or in proximity to the at least one receiving coil 540 (e.g. but not at the same position as the receiving coil 540), wherein a predefined state may be detected in step 410 when a magnetic field measured by said magnetic field sensor exceeds a predefined threshold.

And/or, as an example, at least one part of a metallic structural element of the apparatus may be used as at least one inductive sensor, wherein this at least one inductive sensor may be treated as at least one coil of the at least one further coil. Accordingly, for instance, a signal induced at this at least one inductive sensor may be used for measuring at least one parameter by means of the analyser. For instance, said metallic structural element of the apparatus may represent an element which is configured to carry at least one electronic element and/or non-electronic element of the apparatus, e.g. it may represent a kind of frame or board. This shows the advantage that no further coils are necessary, since this metallic structural element may already be existent in the apparatus 505. As an example, a camera deco of the apparatus might be used as inductive sensor, and/or a part of the chassis of a camera of the apparatus might be used as inductive sensor, and/or a part of a chassis of the apparatus might be used as inductive sensor, and/or an apparatus cover might be used as inductive sensor.

Furthermore, as another example, a predefined state may be detected in step 410 when a waveform of a signal of a coil of the at least one further coil and/or the at least one receiving coils 540 differs from a normal waveform of a signal of this coil. For instance, such a deviating waveform might indicate an external load influencing the electromagnetic wave received at the at least one receiving coil and/or might indicate a misalignment and/or wrong distance between the apparatus and the wireless charger, and thus might be indicative that the transmission power Pin of the wireless charger might exceed a predefined threshold. For instance, said detecting whether a measured waveform deviates from a normal waveform may comprise determining a correlation factor between the measured waveform and the normal waveform, and if the determined correlation factor is less than a predefined value, it is detected that measured waveform deviates from the normal waveform, otherwise no deviation is detected.

Or, for instance, a predefined state may be detected in step 410 when a duty cycle measured by means of a signal of a coil of the at least one further coil and/or the at least one receiving coils differs from a normal duty cycle. As an example, said detecting whether a duty cycle measured at one coil deviates from a normal duty cycle may comprise detecting whether the duty cycle is less than a predefined value and/or higher than a predefined value.

For instance, an analogue to digital converter (ADC) (not depicted in FIGS. 1 and 3 and 5) may be placed between the input 130 of the analyser 120 and each sensor of the at least one sensor, e.g., between each further coil of the at least one further coil 310 and the interface 130 and/or between each receiving coil of the at least one receiving coil 110, 540 in order to convert a measured analogue signal to a corresponding digital value which then can be processed by the analyser 120. Furthermore, for instance, the apparatus 100, 300, 505 may comprise further analogue preprocessing (not depicted in FIGS. 1 and 3 and 5) placed between an input of the ADC and one of the at least one sensors, wherein this analogue preprocessing may comprise a voltage limiter or voltage divider which may for instance be used for reduce the voltage of a signal measured at one further coil of the at least one further coil 310 or measured at one receiving coil of the at least one receiving coil 110, 540, since the peak to peak voltage at an receiving coil 110, 540 or at a further coil 310 may be quite large, e.g., tens of voltages, and thus said voltage divider or voltage limiter may be used for limiting the sensed voltage to a value which can be handled by the ADC and the analyser 120. Furthermore, as an example, the ADC may be considered to be part of the analyser 120.

Furthermore, for instance, said controlling the charging of the rechargeable energy source connected to the interface 140 performed in step 220 may comprise at least one of starting a charging (i.e., switching from non-charging to charging), increasing a charging current during charging, decreasing a charging current during charging, and stopping charging.

If such a predefined state is detected in step 410 based on at least one parameter of the measured at least one parameter, the method 400 may proceed at step 420 depicted in FIG. 4, wherein the analyser 120 controls the charging in accordance with the detected predefined state.

For instance, if the detected predefined state indicates that the transmit power Pin is too high, i.e., the transmit power Pin exceeds a predefined power level, the controlling performed in step 420 may comprise decreasing a charging current when charging of a rechargeable energy source connected to the interface 140 is performed or stopping the charging, or, if no charging is performed, preventing starting charging a rechargeable energy source connected to the interface 140. A similar (or same) controlling may be performed in step 420 if the detected predefined states indicates that the distance (or an absolute value of the distance) between the apparatus 100, 300, 505 and the wireless charger 550 exceeds a maximum predefined distance (e.g., in at least on of a x-, y- or z-direction of a coordinate system), or if the detected predefined state indicates that an external load is detected, or if the detected predefined state indicates that there is a misalignment between the apparatus 100, 300 and the wireless charger.

Afterwards, the method 400 may jump to the beginning, i.e., from reference sign 425 to reference sign 405. Then, for instance, if a normal predefined state is detected in step 401, wherein a normal state may represent any state which enables wireless charging with sufficient efficiency, e.g., the transmit power Pin being less or equal to the above mentioned power level threshold may indicate a normal state, then the method may detect this normal state as a predefined state and may start charging at step 420 if no charging is performed so far, or may increase the charging current if charging is performed.

Furthermore, for instance, said normal state may be present if it is detected that the distance (or an absolute value of the distance) between the apparatus 100, 300, 505 and the wireless charger 500 is less than a predefined maximum distance, and/or if it is detected there is no external load, and/or if it is detected that there is no misalignment.

Thus, the method 400 depicted in FIG. 4 allows to control the charging in accordance with the actual operating scenario, wherein the controlling is performed based on the measured at least one parameter being indicate of a property of the wireless signal of a wireless charger.

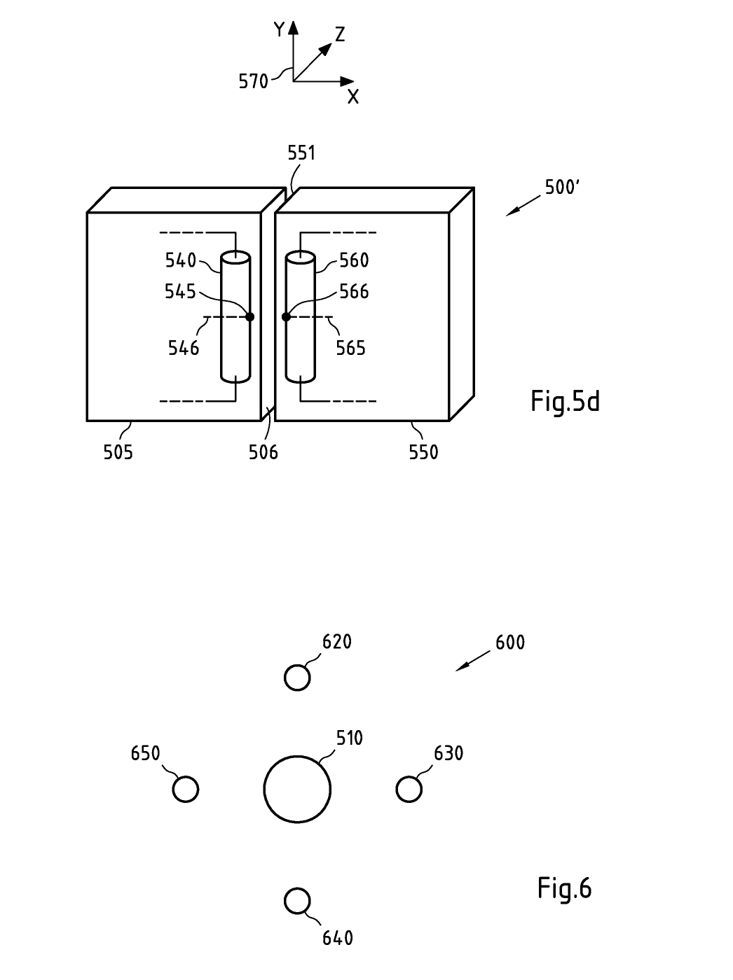

FIG. 6 depicts an example embodiment of an arrangement 600 of at least one receiving coil 610 and a plurality of further coils 620, 630, 640, 650 according to an aspect of the invention. This arrangement 600 may for instance be used for any of the apparatus 100, 300, 505 depicted in FIGS. 1, 3 and 5. The at least one receiving coil may for instance represent the at least one receiving coil 110 depicted in FIGS. 1 and 3 or the at least one receiving coil 540 depicted in FIG. 5d, and the plurality of further coils 620, 630, 640, 650 may for instance represent the at least one further coil 310 of apparatus 300.

The further coils 620, 630, 640, 650 of the plurality of further coils 620, 630, 640, 650 are arranged at predefined positions around or near the at least one receiving coil 610.

The analyser 120 might be configured to determine a misalignment of a position of the at least one receiving coil 610 with respect to a position of a wireless charger based on a measured parameter from a signal provided by at least one of the plurality of further coils 620, 630, 640, 650. For instance, this detection of a misalignment may be performed as mentioned with respect to method 400, wherein, for instance, if a level of a signal detected at one of the plurality of further coils 620, 630, 640, 650 exceeds a predefined threshold, it may be detected that there is a misalignment since this coil receives too much energy which might indicate a misalignment. Further, as an example, the levels of the signals of different coils of the further coils 620, 630, 640, 650 may be compared to each other in order to detect a misalignment.

The analyser 120 might be configured to provide information on the detected misalignment to a user via a user interface, which may represent a display and/or an optical interface, and, as an example, the analyser 120 might be configured to provide directional information for correcting the misalignment via this user interface. For instance, the analyser 120 might be configured to visualize the positions of the plurality further coils 620, 630, 640, 650 and of the at least one receiving coil 610 on a display and might visualize the levels of the signals measured at the different further coils of the plurality further coils 620, 630, 640, 650. Thus, if the arrangement of the plurality of further coils 620, 630, 640, 650 represents a symmetric arrangement of further coils around the at least one receiving coil, as exemplarily depicted in FIG. 6, the user would be at least inherently informed to move the apparatus in a direction where the levels of the different further coils are substantially the same in order to optimize wireless energy transfer to the at least one receiving coil 610.

Or, as another example, the analyser might calculate directional information for correcting the misalignment based on signal levels of at least two of the plurality of further coils 620, 630, 640, 650, and might be configured to present this directions information via the user interface, e.g. by means of an arrow indication the direction the apparatus should be moved, or by means of an acoustic output.

Thus, as an example, the plurality of further coils 620, 630, 640, 650 may not only used to detect the predefined state of a misalignment, but may also be used for generating and providing directional information on how to correct the misalignment to a user via an interface.

For instance, said signal levels may represent amplitude levels, e.g., voltage level, measured at each of the plurality of further coils 620, 630, 640, 650.

Furthermore, it has to be understood that his example of using the at least one receiving coil 610 and/or the at least on further coil 620, 630, 640, 650 as at least one sensor for detecting a misalignment by the analyser 120 represents an example. Thus, as an example, the analyser 120 might be configured to use at least one further sensor for detecting a misalignment compared to the above-mentioned at least one sensor, wherein said at least one further sensor might for instance comprise at least one optical sensor or any other well-suited sensor. For instance, this at least one further sensor might be used without using the at least one receiving coil 610 and the at least on further coil 620, 630, 640, 650, or, as another example, in addition to the at least one receiving coil 610 and/or the at least on further coil 620, 630, 640, 650.

As used in this application, the term ‘circuitry’ refers to all of the following:

(a) hardware-only circuit implementations (such as implementations in only analog and/or digital circuitry) and

(b) combinations of circuits and software (and/or firmware), such as (as applicable):

(i) to a combination of processor(s) or

(ii) to portions of processor(s)/software (including digital signal processor(s)), software, and memory(ies) that work together to cause an apparatus, such as a mobile phone or a positioning device, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a positioning device.

With respect to the aspects of the invention and their embodiments described in this application, it is understood that a disclosure of any action or step shall be understood as a disclosure of a corresponding (functional) configuration of a corresponding apparatus (for instance a configuration of the computer program code and/or the processor and/or some other means of the corresponding apparatus), of a corresponding computer program code defined to cause such an action or step when executed and/or of a corresponding (functional) configuration of a system (or parts thereof).

The aspects of the invention and their embodiments presented in this application and also their single features shall also be understood to be disclosed in all possible combinations with each other. It should also be understood that the sequence of method steps in the flowcharts presented above is not mandatory, also alternative sequences may be possible.

The invention has been described above by non-limiting examples. In particular, it should be noted that there are alternative ways and variations which are obvious to a skilled person in the art and can be implemented without deviating from the scope and spirit of the appended claims.

1-39. (canceled)

40. An apparatus, comprising:
at least one receiving coil configured to receive electromagnetic energy from a wireless signal provided by a wireless charger,
an interface connected to the at least one receiving coil and configured to be connected to a rechargeable energy source for charging the rechargeable energy source with energy received at the at least one receiving coil,
an analyser configured to measure at least one parameter being indicative of a property of the wireless signal provided by the wireless charger and configured to control charging of the rechargeable energy source connected to the interface based on the at least one measured parameter.

41. The apparatus according to claim 40, wherein the analyser is further configured to detect a predefined state of the wireless signal based on at least one parameter of the at least one measured parameter, wherein the charging of the rechargeable energy source connected to the interface including at least one of:
reducing a charging current provided to the rechargeable energy source if the predefined state of the wireless signal is detected,
increasing a charging current provided to the rechargeable energy source if the predefined state of the wireless signal is detected,
stopping the charging of the rechargeable energy source if the predefined state of the wireless signal is detected,
preventing start of charging of the rechargeable energy source if the predefined state of the wireless signal is detected.

42. The apparatus according to claim 40, further comprising at least one sensor, wherein the analyser is configured to measure a parameter of at least one of the at least one parameter based on a signal provided by each of said at least one sensor,
wherein one sensor of the at least one sensor represents at least one further coil configured to receive electromagnetic energy,
wherein one coil of the at least one further coil at least partially surrounds one receiving coil of the at least one receiving coil, and
wherein the one coil of the at least one further coil is placed in proximity to the one receiving coil of the at least one receiving coil.

43. The apparatus according to claim 42, wherein the predefined state of the wireless signal is detected based on at least one of the following:
a voltage measured at the one coil of the at least one further coils exceeds a predefined voltage threshold,
a frequency measured at the one coil of the at least one further coils is less than a predefined frequency threshold, and
a frequency measured at the one coil of the at least one further coils is higher than a predefined frequency threshold, and
wherein the analyser is further configured to determine a misalignment of a position of the at least one receiving coil with respect to a position of the wireless charger based on a signal provided by the at least one further coil, and wherein the apparatus comprises an interface configured to provide directional information for correcting the misalignment.

44. The apparatus according to claim 43, wherein said at least one coil represents at least two further coils arranged at predefined positions around the at least one receiving coil,
wherein said determining a misalignment is performed based on a measured signal level of the signal of said at least two further coils.

45. The apparatus according to one of claim 42, wherein the at least one sensor comprising any combination of one or more of the following:
a temperature sensor,
a magnetic field sensor, and
a structural element of the apparatus,
wherein a sensor of the at least one sensor is placed in proximity to a receiving coil of the at least one receiving coil.

46. The apparatus according to claim 40, wherein the analyser is configured to measure the parameter of at least one of the at least one parameter based on a signal provided by the at least one receiving coil,
wherein the predefined state of the wireless signal is detected based one of the following:
a frequency measured at a receiving coil of the at least one receiving coils is less than a predefined frequency threshold, and
a frequency measured at a receiving of the at least one further coils is higher than a predefined frequency threshold.

47. The apparatus according to claim 41, wherein the analyser is configured to determine a power received by the at least one receiving coil, wherein the analyser is further configured to detect the predefined state of the wireless signal if said measured power is approximately constant while a parameter of one of the at least one parameter changes significantly, and wherein said predefined state indicates that the transmit power of the wireless charger exceeds a predefined power level.

48. The apparatus according to claim 40 wherein said measured at least one parameter is associated with one or more of:
a signal level associated with the wireless signal,
a waveform associated with the wireless signal,
a duty cycle associated with the wireless signal,
a frequency associated with the wireless signal,
a temperature, and
an amplitude of a magnetic field.

49. The apparatus according to claim 40, wherein said apparatus is a mobile phone.

50. A method performed by an apparatus, comprising:
measuring at least one parameter indicative of a property of a wireless signal provided by a wireless charger,
receiving, using at least one receiving coil of the apparatus, electromagnetic energy from a wireless signal provided by the wireless charger, and
controlling a charging of a rechargeable energy source with energy received at the at least one receiving coil based on the at least one measured parameter.

51. The method according to claim 50, comprising detecting a predefined state of the wireless signal based on at least one parameter of the at least one measured parameter, wherein said controlling the charging of a rechargeable energy source connected to the interface includes at least one of:
reducing a charging current provided to the rechargeable energy source if the predefined state of the wireless signal is detected,
increasing a charging current provided to the rechargeable energy source if the predefined state of the wireless signal is detected,
stopping the charging of the rechargeable energy source if the predefined state of the wireless signal is detected,
preventing start of charging of the rechargeable energy source if the predefined state of the wireless signal is detected.

52. The method according to claim 50, wherein the apparatus further comprising at least one sensor, the method comprising measuring a parameter of at least one of the at least one parameter based on a signal provided by each of said at least one sensor,
wherein one sensor of the at least one sensor represents at least one further coil configured to receive electromagnetic energy,
wherein one coil of the at least one further coil at least partially surrounds one receiving coil of the at least one receiving coil, and
wherein one coil of the at least one further coil is placed in proximity to the one receiving coil of the at least one receiving coil.

53. The method according to claim 52, wherein the predefined state of the wireless signal is detected based on at least one of the following:
a voltage measured at the one coil of the at least one further coils exceeds a predefined voltage threshold,
a frequency measured at the one coil of the at least one further coils is less than a predefined frequency threshold, and
a frequency measured at the one coil of the at least one further coils is higher than a predefined frequency threshold, and
comprising determining a misalignment of a position of the at least one receiving coil with respect to a position of the wireless charger based on a signal provided by the at least one further coil, and wherein the apparatus comprises an interface configured to provide directional information for correcting the misalignment.

54. The method according to claim 53, wherein said at least one coil represents at least two further coils arranged at predefined positions around the at least one receiving coil,
wherein said determining a misalignment is performed based on a measured signal level of the signal of said at least two further coils.

55. The method according to claim 52, wherein the at least one sensor comprising any combination of one or more of the following:
a temperature sensor,
a magnetic field sensor, and
a structural element of the apparatus, and
wherein a sensor of said the at least one sensor is placed in proximity to a receiving coil of the at least one receiving coil.

56. The method according to claim 50, comprising measuring the parameter of at least
one of the at least one parameter based on a signal provided by the at least one receiving coil, wherein the predefined state of the wireless signal is detected based on one of the following:
a frequency measured at a receiving coil of the at least one receiving coils is less than a predefined frequency threshold, and
a frequency measured at a receiving coil of the at least one further coils is higher than a predefined frequency threshold.

57. The method according to claim 51, comprising determining a power received by the at least one receiving coil, and detecting the predefined state of the wireless signal if said measured power is approximately constant while a parameter of one of the at least one parameter changes significantly, and
wherein said predefined state indicates that the transmit power of the wireless charger exceeds a predefined power level.

58. The method according to claim 50, wherein said measured at least one parameter is associated with one or more of:
a signal level associated with the wireless signal,
a waveform associated with the wireless signal,
a duty cycle associated with the wireless signal,
a frequency associated with the wireless signal,
a temperature, and
an signal level of a magnetic field.

59. A computer program product comprising a least one computer readable non-transitory medium having program code stored thereon, the program code, when executed by an apparatus, causes the apparatus to measure at least one parameter representative being indicative of a property of a wireless signal provided by a wireless charger, wherein the apparatus comprises at least one receiving coil configured to receive electromagnetic energy from a wireless signal provided by the wireless charger, and to control a charging of a rechargeable energy source connected to an interface of the apparatus based on the at least one measured parameter, wherein the interface is connected to the at least one receiving coil and configured to be connected to a rechargeable energy source for charging the rechargeable energy source with energy received at the at least one receiving coil.
